(19) United States
(12) Patent Application Publication
(10) Pub. No.: US 2012/0144707 A1
(43) Pub. Date: Jun. 14, 2012

(54) ADJUSTABLE SIGN HOLDER DEVICE

(76) Inventor: Benjamin L. Garfinkle, Piedmont, CA (US)

(21) Appl. No.: 13/372,431

(22) Filed: Feb. 13, 2012

Related U.S. Application Data
(63) Continuation-in-part of application No. 12/122,888, filed on May 19, 2008.
Application No. 12/122,888 is a continuation-in-part of application No. 11/888,108, filed on Jul. 31, 2007.
Application No. 11/888,108 is a continuation of application No. 10/147,669, filed on Jul. 22, 2002.
Application No. 10/147,669 is a division of application No. 09/684,726, filed on Oct. 6, 2000, now Pat. No. 6,530,166.

(51) Int. Cl. G09F 15/00

(52) U.S. Cl. 40/607.04

(57) ABSTRACT

A sign holder device for the support and display of signage. The device includes a base, sign holder and a stem, the stem having a first end appended to the base and a second end supporting the sign holder. The stem has a length defined by the distance between its first and second ends, the length being adjustable to vary the distance between the base and sign holder.

### RELATED APPLICATIONS

The present application is a continuation-in-part of U.S. application Ser. No. 12/122,888 filed on May 19, 2008 which is in turn a continuation-in part of U.S. application Ser. No. 11/888,108 filed on Jul. 31, 2007 which is a continuation of U.S. application Ser. No. 10/147,669 filed on Jul. 22, 2002 which is, in turn, a divisional of U.S. application Ser. No. 09/684,726 filed on Oct. 6, 2000 and issued as U.S. Pat. No. 6,530,166 on Mar. 11, 2003.

### TECHNICAL FIELD

The present invention is directed to a sign holder device in the form of parts which, upon assembly, provide for the support and display of signage. The sign holder device can be used in a number of environments most notably in retail food establishments and is configured to enable a user to alter a sign's orientation and to enable a sign holder to be vertically raised and lowered through the use of a stem adjustable in length.

### BACKGROUND OF THE INVENTION

Retail establishments such as supermarket chains require signage of every imaginable configuration. Every product sold requires some type of sign to inform a consumer of the nature and price of products on display. For example, produce such as oranges, bananas and grapefruit require one type of signage while frozen food bins and deli cases yet others. It is impractical for a multi-product retail establishment such as a grocery chain to inventory preassembled signage for each dedicated orientation. A far better solution is to provide the retailer with an inventory of parts which can be assembled on site depending upon the product display requiring such signage.

The present invention is not the first instance in which it was suggested that retail store signage be provided from a parts bin rather than as assembled members. However, prior knockdown component oriented kits have not been universally embraced by the retail trade for several reasons. Products of this nature of the prior art tend to be flimsy, and not easily assembled and disassembled and oftentimes require a certain level of skill and experience in converting the bin of parts to professionally looking customer-inviting signage. To be successful the parts must be able to assume a wide variety of orientations as retail food displays, from produce to fish to meats and dairy have their own unique signage requirements. Among them is the need to be able to adjust the height of the signage from its supporting base structure. For example, an easel base can be placed upon the surface of an empty display case which is then stacked with oranges, apples or the like in a pyramid fashion. In such an environment, it would be quite important to be able to vertically raise the sign holder sufficiently high to clear the mound of produce to which the sign relates; and to be able to lower the sign as the amount of produce diminishes.

Others have suggested telescoping arms for various purposes. For example, U.S. Pat. No. 4,329,800 to Shuman teaches a telescoping stem having components parts which are provided with arms having a set of teeth which interact a second set of teeth to enable the stem to change its length in a ratchet-like action. Shuman's tube having threads results in a complex arrangement representing a poor telescoping arm both in terms of complexity of operation and cost of fabrication. Its complexity results in a product more inclined to misalign and break in the field. As the Shuman device allows his telescoping stem to rotate within its sleeve, maintaining signage to always be visible to consumers is virtually impossible.

Telescoping arms have also been used in other, nonrelated environments. For example, U.S. Pat. No. 5,169,226 to Friedman teaches a self-contained light source in the form of a portable desktop lamp which includes a telescoping arm. Such construction does not lend itself to displaying signage in a retail environment, such as a food retailer. Among its other deficiencies, Friedman serpentines a power cord from the base of his lighting device to its bulb housing. This prevents the inner shaft and outer sleeve of Friedman from being removed from one another, a feature which is highly desirable in devices used in the food industry as the disassembly of parts for cleaning reduces the possibility of pathogen and bacteria formation grown from organics and food items which may find themselves within the stem of any such signage. This problem can be particularly acute in considering Friedman's structural features. Food particles and other debris can lodge within elongated groove 44 and spaced traverse grooves 48 of his distal arm shaft 42 as well as flap 52 of his outer shaft 40.

Similarly, food items can lodge within any relief feature on the exterior of such signage. As such, any preferred stem for use in the food industry should ideally have an outer surface devoid of any features associated with any protrusions or indents contained therein.

It is thus an object of the present invention to provide a sign holder device having a stem between the base of the device and the sign holder. The stem can be included within a bin of parts to enable it to be employed with bases of various varieties and sign holders of a multitude of configurations. In this regard, reference is made to parent U.S. Pat. No. 6,530,166 disclosing a multitude of bases such as easel bases and those which can be employed between wooden slats and joined to parallel extending wires generally found in refrigerated cases. To that extent, the disclosure of U.S. Pat. No. 6,530,166 is incorporated herein by reference. The present invention can be employed with each of them.

### SUMMARY OF THE INVENTION

A sign holder device for the support and display of signage. The device includes a base, sign holder and a stem, the stem having a first end appended to the base and a second end supporting the sign holder. The stem has a length defined by the distance between its first and second ends, the length being adjustable to vary the distance between the base and sign holder.

### BRIEF DESCRIPTION OF THE FIGURES

FIG. 1 is a perspective view of a typical sign holder device embracing the inventive concepts of the present invention.

FIGS. 2 and 3 are side views of the sign holder device of FIG. 1 having its stem elevated and retracted as illustrative of the use of the present invention enabling the user to establish varying heights of the sign holder.

FIG. 4 is a side view showing a portion of the stem of the present invention.

FIG. 5 is a side view showing a preferred feature of the present invention, that is, the complete removability of the inner shaft from its outer sleeve to enhance cleaning of this device.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

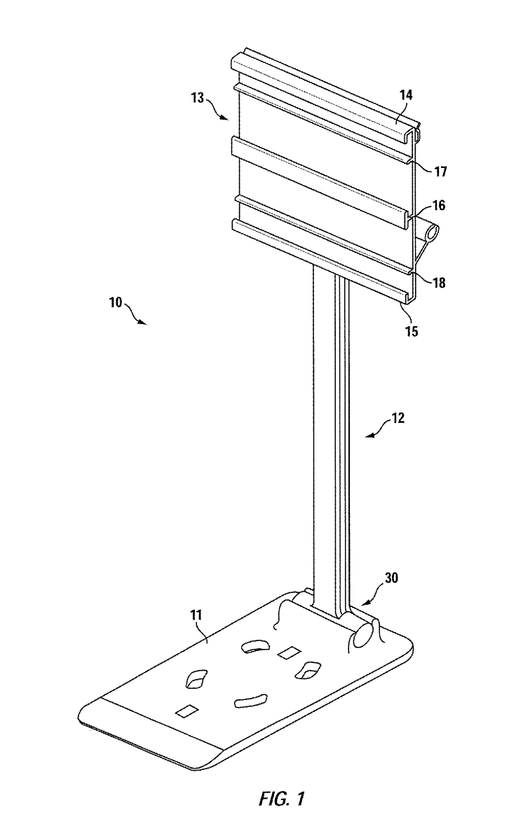

An illustration of the present invention is depicted in FIG. 1. Specifically, sign holder device 10 is shown having base 11 supporting stem 12. In this illustration, base 11 is an easel base although any of the other functional bases commonly employed in retail settings can be used as part of the sign holder device of this invention. Examples of suitable bases are disclosed in applicant's previously issued U.S. Pat. No. 6,530,166, the disclosure of which is incorporated by reference herein.

Although the interface between base 11 and stem 12 can take on a number of alternative configurations while remaining within the spirit and scope of the present invention, in the illustration as shown, base 11 incorporates a C-shaped receiving channel 41 sized to frictionally engage cylindrical portion 40 of stem 12.

The configuration of stem 12 represents an important feature of the present invention. Stem 12 has first end 30 appended to base 11 as discussed previously. Second end 20 of stem 12 supports a sign holder such as sign holder 13 illustrated herein. Although sign holder 13 can take on a multitude of physical embodiments, in the illustration as shown, lips 14 and 15 extend at the upper and lower horizontal edges thereof, respectively, to receive product information, such as pricing, when ledge 16 is located between them. Signage, such as pricing and other product information, is slid within the two channels created and maintained in a “bowed” configuration by raised portions 17 and 18.

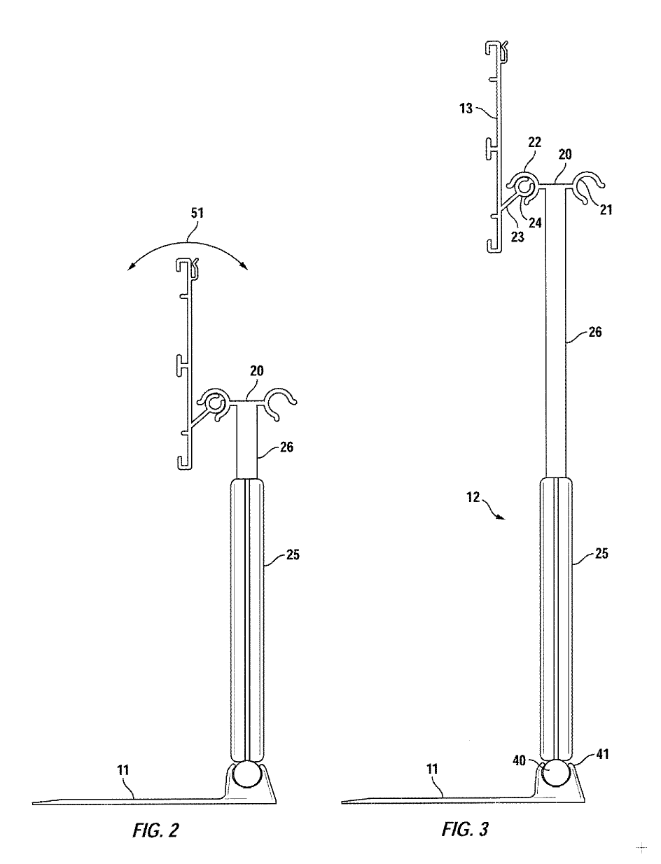

Sign holder 13, in its preferred embodiment, is located proximate second end 20 of stem 12 and is connected thereto by diagonally extending support 23 terminating in cylindrical element 24 which is frictionally received by C-shaped channel 22. As noted in FIGS. 2 and 3, C-shaped channels 22 and 21 can be configured on opposite sides of stem 12 to increase the flexibility of the present invention. In any regard, by employing this illustrated geometry, sign holder 13 can be caused to rotate in the directions of arrow 51 to assist in positioning signage appearing thereon to be directed at the anticipated viewing angle of a consumer.

As noted previously, an important feature of the present invention is employing stem 12 having a length adjustable to vary the distance between the base and sign holder. This greatly enhances the flexibility of the present invention by enabling the present sign holder to be used in a multitude of environments where signage spacing from base to sign holder is to be varied.

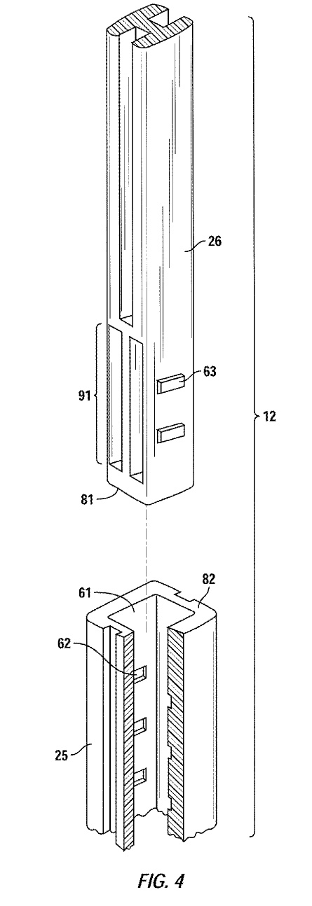

As shown in FIGS. 1-3, stem 12 comprises inner shaft 26 and outer sleeve 25. An illustration of the detail of movement between the inner shaft and outer sleeve is shown in FIG. 4. As illustrated, inner shaft 26 is provided with protrusions 63 positioned as shown on this side wall of shaft 26 and located at thinned-wall section 91. Alternatively, protrusions could be configured on the inside wall of the outer sleeve 25 with indents 62 configured within inner shaft 26 also at thinned-wall section 91 while remaining within the scope of the present invention. In either case, as inner shaft 26 is moved along outer sleeve 25, inner shaft 26 is caused to fit within space 61 while protrusions snap release along indents to provide a stutter motion facilitated by thinned-wall section 91 as stem 12 is extended or retracted. In doing so, the vertical height of signage 13 can be varied to, again, supplement the flexibility of the present invention.

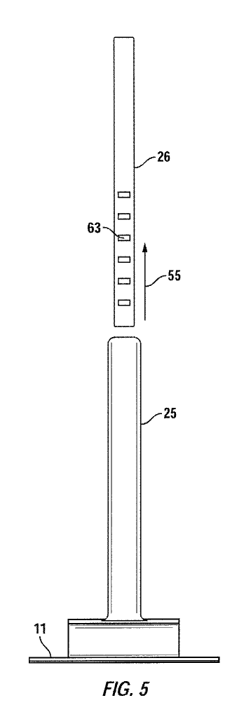

As noted previously, the present invention is intended to be used in a retail environment to support signage and, particularly, in a retail environment in which food products are vended. In such establishments, such as large supermarkets, food debris can oftentimes lodge between inner shaft 26 and outer sleeve 25. Unless such signage is routinely cleaned, these foodstuffs can result in the breeding of bacteria and pathogens, a situation which is unacceptable when dealing with products intended to be ingested. As such, as a preferred embodiment, reference is made to FIG. 5 showing that inner shaft 26 including protrusion 63 can be pulled in the direction of arrow 55 and completely removed from outer sleeve 25. In doing so, the entire length of inner shaft 26 can be cleaned as well as the inner walls of outer sleeve 25. Complete removability also enhances visual inspection to enable counter staff to satisfy themselves that no foodstuffs have lodged between inner shaft 26 and outer sleeve 25 to enable them to take remedial action when necessary.

As is also apparent from the various figures made part of the present application, as a preferred embodiment, outer sleeve 25 is devoid of any features associated with protrusions 63 or indents 62. The stem of the present invention thus is not only visually appealing but outer sleeve 25 is devoid of any features which, themselves, would trap food debris which, again, could result in a breeding ground for bacteria and pathogens. Outer sleeve 25 being devoid of features associated with protrusions and indents makes the outer surface of the outer sleeve relatively easy to clean and presents a far superior alternative to any stem-like product built without sensitivity to this issue.

In further reference to FIG. 4, it is noted that, as a preferred embodiment, protrusions 63 are located only proximate first end 81 of inner shaft 26 so that the side wall of inner shaft 26 is devoid of any features as it telescopes from space 61 extending beyond top edge 82 of outer sleeve 25. As a more preferred embodiment, only four such protrusions 63 are employed in order to maximize the telescoping length of stem 12 free of protrusions 63 appearing above top surface 82 of outer sleeve 25. As shown two protrusions appear on a side of said shaft 26 and a mirror pair, although not visible are on the opposite sides of shaft 26.

As further noted previously, telescoping stems, such as those disclosed in Shuman's '800 patent, are oftentimes configured of complex subparts which are subject to breakage and, importantly, difficult to fabricate. An advantage of the present invention is its ease of fabrication which lowers part costs and encourages adoption of this invention by retailers.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A sign holder device for the support and display of signage, said sign holder device comprising a base, sign holder and a stem, said stem having a first end appended to said base and a second end for supporting a sign holder, said stem having a length defined by the distance between said first and second ends, said length being adjustable to vary the distance between said base and sign holder by providing said stem with an inner shaft and outer sleeve, said inner shaft having an outer surface and said outer sleeve having an inner surface, said sign holder device further including at least one protrusion and at least one indent provided for snap-release contact as said inner shaft and outer sleeve move with respect to one another, said at least one protrusion being either on the outer surface of said inner shaft or inner surface of said outer sleeve while said at least one indent being located on the outer surface of said inner shaft or inner surface of said outer sleeve and wherein said inner shaft is incapable of freely rotating within said outer sleeve, and when said inner shaft is completely removable from said outer sleeve by withdrawing said inner shaft from said outer sleeve.

2. A sign holder device for the support and display of signage, said sign holder device comprising a base, sign holder and a stem, said stem having a first end appended to said base and a second end for supporting a sign holder, said stem having a length defined by the distance between said first and second ends, said length being adjustable to vary the distance between said base and sign holder by providing said stem with an inner shaft and outer sleeve, said inner shaft having an outer surface and said outer sleeve having inner and outer surfaces, said sign holder device further including at least one protrusion and at least one indent provided for snap-release contact as said inner shaft and outer sleeve move with respect to one another, said at least one protrusion being either on the outer surface of said inner shaft or inner surface of said outer sleeve while said at least one indent being located on the outer surface of said inner shaft or inner surface of said outer sleeve and wherein said inner shaft is incapable of freely rotating within said outer sleeve, said outer surface of said outer sleeve being devoid of any features associated with said protrusions and indents.

3. The sign holder device of claim 2 wherein said sign holder is rotatable with respect to said stem to alter the orientation of said sign holder to said stem.

4. A sign holder device for the support and display of signage, said sign holder device comprising a base, sign holder and a stem, said stem having a first end appended to said base and a second end for supporting a sign holder, said stem having a length defined by the distance between said first and second ends, said length being adjustable to vary the distance between said base and sign holder by providing said stem with an inner shaft and outer sleeve, said inner shaft having an outer surface and said outer sleeve having inner and outer surfaces and a top edge, said sign holder device further including at least one protrusion and at least one indent provided for snap-release contact as said inner shaft and outer sleeve move with respect to one another, said at least one protrusion being either on the outer surface of said inner shaft or inner surface of said outer sleeve while said at least one indent being located on the outer surface of said inner shaft or inner surface of said outer sleeve and wherein the outer surface of said inner shaft being devoid of any features associated with said protrusions and indents for that portion of said inner shaft that extends above the top edge of said outer sleeve.

5. The sign holder device of claim 4 wherein said inner shaft is provided with an end characterized as extending furthest within said outer sleeve when said base and sign holder are brought closest together, said indents or protrusions configured on the outer surface of said inner shaft being located only proximate to said end.

6. The sign holder device of claim 5 wherein four protrusions or indents are located on the outer surface on said inner shaft proximate said end thereof.

7. The sign holder device of claim 1 wherein said protrusions are located on said inner shaft on a thinned-wall section thereof.

8. A sign holder device for the support and display of signage, said sign holder device comprising a base, sign holder and a stem, said stem having a first end appended to said base and a second end for supporting a sign holder, said stem having a length defined by the distance between said first and second ends, said length being adjustable to vary the distance between said base and sign holder by providing said stem with an inner shaft and outer sleeve, said inner shaft having an outer surface and said outer sleeve having an inner surface, said sign holder device further including at least one protrusion and at least one indent provided for snap-release contact as said inner shaft and outer sleeve move with respect to one another, said at least one protrusion being on the outer surface of said inner shaft while said at least one indent being located on the inner surface of said outer sleeve and wherein said at least one protrusion is located on said inner shaft on a thinned-wall section thereof.

9. A sign holder device for the support and display of signage, said sign holder device comprising a base, sign holder and a stem, said stem having a first end appended to said base and a second end for supporting a sign holder, said stem having a length defined by the distance between said first and second ends, said length being adjustable to vary the distance between said base and sign holder by providing said stem with an inner shaft and outer sleeve, said inner shaft having an outer surface and said outer sleeve having an inner surface, said sign holder device further including at least one protrusion and at least one indent provided for snap-release contact as said inner shaft and outer sleeve move with respect to one another, said at least one protrusion being on the inner surface of said outer sleeve while said at least one indent being located on the outer surface of said inner shaft and wherein said at least one indent is located on said inner shaft on a thinned-wall section thereof.
